(19) United States
(12) Patent Application Publication
(10) Pub. No.: US 2004/0076462 A1
(43) Pub. Date: Apr. 22, 2004

(54) Ready-to-be-filled container and a method of producing the same

(75) Inventor: Andre Grandmottet, Saint Lupicin (FR)

Correspondence Address: YOUNG & THOMPSON, 745 SOUTH 23RD STREET 2ND FLOOR, ARLINGTON, VA, 22202

(73) Assignee: VERCHERE PLASTIQUES INDUSTRIELS, ORGELET (FR)

(21) Appl. No.: 10/681,177

(22) Filed: Oct. 9, 2003

(30) Foreign Application Priority Data
Oct. 9, 2002 (FR) 0212560

(51) Int. Cl. B43K 21/02

(52) U.S. Cl. 401/55; 401/188 R

(57) ABSTRACT

A ready-to-be-filled container (1) intended for producing a dispenser for a product such as a cosmetic product, a perfume or the like, comprising

means (9) for containing the product, having a product filling opening (16) and a product dispensing opening (18);

means (3) for dispensing the product, such as a pump, mounted on the means (9) for containing the product and responsive to control means (34);

means (20) forming an external casing, made from plastics material, for the means (9) for containing the product and for the means (3) for dispensing the product, with which the control means (34) are associated, having a product dispensing aperture (31) matching the outlet for the means (3) for dispensing the product, and an opening (39) for mounting the container (1);

the product filling opening (16) being intended, in the dispenser (2), to be closed by closure means (40);

the container (1) thus being ready to be filled with the product and then closed by the closure means (40) in order to form the dispenser.

The invention concerns a ready to be filled container intended for producing a dispenser for a product such as a cosmetic product, a perfume or the like, a reservoir in the container intended to contain the product, a casing forming the outside of the container and a method of producing the container.

The invention also concerns a product dispenser comprising the said container and the method of producing the dispenser.

From the document FR-A-2 815 522, a dispenser for a perfume to be vaporised is known, comprising a casing, a reservoir and a pump.

The reservoir is essentially parallelepipedal and has on one of its faces an opening intended firstly to enable the reservoir to be filled with the product and secondly to receive the pump.

The pump comprises in particular a body situated inside the reservoir, and an atomisation head situated outside, from which a product-dispensing nozzle extends in projection.

The casing is parallelepipedal. One of its small lateral faces comprises an aperture intended to have the nozzle pass through it for dispensing the product.

One of its large lateral faces is open over its entire surface and is intended to be closed during the mounting of the dispenser.

The mounting of the dispenser takes place in accordance with the following steps:

the reservoir is filled with product;

the pump is placed on the reservoir;

the reservoir, provided with the pump, is inserted in the casing through the opening on one of the large lateral faces by manipulating the reservoir so as to make the dispensing nozzle pass through the aperture provided for this purpose;

the opening is closed.

In the method of producing such a dispenser, it is clear that, after the filling of the reservoir, several important steps remain to be performed.

Thus the filling step divides the production method into two distinct mounting phases, carried out at different places and by distinct persons.

Generally, the steps preceding the filling are carried out by persons whose job is to produce a container ready to be filled.

The filling is carried out by other persons, who also take responsibility for the last steps of producing the dispenser.

Consequently, although having the competences for performing all the steps of the method with the exception of the filling, the persons producing the ready-to-be-filled container can take responsibility only for a first part of the method of producing the dispenser.

Some of the workload which could fall to them is transferred to the persons responsible for the filling.

The filling of the reservoir during the manufacture of the dispenser therefore has an effect on the distribution of the workload between the two groups of persons taking part in this manufacture to the detriment of the manufacturers of the ready-to-be-filled container.

Moreover, another drawback of this type of method results from the difficulty in inserting the reservoir in the casing because of the presence of the nozzle on the pump head.

The aim of the invention is to propose another design of the ready-to-be-filled container not having the above drawbacks. In addition to a greater ease in mounting the components making it up in one another, the product filling step is pushed to the end of the process. This makes it possible to group together the majority of the steps of assembling the container before the filling.

According to a first aspect, the invention concerns a ready-to be-filled container intended for producing a dispenser for a product such as a cosmetic product, a perfume or the like, comprising

means for containing the product, having a product filling opening and a product dispensing opening;

means for dispensing the product, such as a pump, mounted on the means for containing the product and responsive to control means;

means forming an external casing, made from plastics material, for the means for containing the product and for the means for dispensing the product, with which the control means are associated, having a product dispensing aperture matching the outlet for the means for dispensing the product, and a container mounting opening;

the product filling opening being intended, in the dispenser, to be closed by closure means;

the container thus being ready to be filled with the product and then closed by the closure means in order to form the dispenser.

According to the embodiments, the means for containing the product are in the form of a reservoir distinct from the means forming the casing and are placed in the latter or are formed from one and the same piece.

In the case where there are two distinct pieces, the reservoir can comprise several faces; on one of them there is the filling opening, and on another there is the product dispensing opening. These two openings can be situated on two opposite faces.

The mounting opening provided on the means forming a casing can enable the reservoir to be inserted.

Respective means for fixing the means forming the casing and the reservoir can be provided on the means forming the casing and/or on the reservoir.

In the case where the means forming a casing and the reservoir are formed from one and the same piece, this casing/reservoir can comprise the filling/mounting opening and the product dispensing opening, the dispensing means being able to be placed on the casing/reservoir on each side of the product dispensing opening.

The means forming a casing can comprise several faces, one of them being able to comprise the mounting opening, another being able to comprise a cavity comprising the product dispensing opening. These two faces may be opposite faces.

The closure means can comprise a pivoting wall pivoting about an edge forming a hinge for the means forming a casing. The pivoting wall can comprise means of closing off the projecting filling opening.

According to a second aspect, the invention concerns a reservoir comprising a filling opening and a product dispensing opening, the filling opening making it possible to fill the said reservoir with product, the product dispensing opening being intended to receive product dispensing means.

According to a third aspect, the invention concerns a casing comprising a mounting opening, a product dispensing aperture intended to be in correspondence with the outlet from the means for dispensing the product and means of controlling the means for dispensing the product.

According to a fourth aspect, the invention concerns a method of producing the container comprising the following steps:

means for dispensing the product, such as a pump, are procured;

means forming a casing, made from plastics material, are procured, the means forming a casing comprising a mounting opening;

the means forming a casing and the means for dispensing the product are associated together so as to place the means for dispensing the product on the means forming the casing

so that the mounting opening is open, the container thus being ready to be filled with the product and then closed by the closure means in order to form the dispenser.

The method can also comprise the following steps:

means are also procured for containing the product comprising a filling opening and an opening for dispensing the product;

the means for dispensing the product are placed on the means for containing the product on each side of the opening for dispensing the product;

the means for containing the product are introduced into the means forming a casing through the mounting opening

so that the mounting opening and the filling opening are opposite each other and are open, the container thus being ready to be filled with the product and then closed by the closure means in order to form the dispenser.

According to a fifth aspect, the invention concerns a dispenser comprising a container as described above, the product to be dispensed placed in the means for containing the product and means of closing the container which close off the mounting opening.

The closure means can comprise a first wall, such as a rigid plate, a film made from plastics material or the like, intended to close the filling opening, and a second wall, such as a rigid plate, a film made from plastics material or the like, closing the mounting opening.

The first and second walls and the pivoting wall of the container can be associated with the means for containing the product by a method chosen from amongst the group comprising adhesive bonding, welding, heat sealing, screwing and snapping on.

According to a sixth aspect, the invention concerns a method of producing a dispenser as described above, comprising the following steps:

a ready-to-be-filled container is produced by the method of producing a container as described above;

the container is filled with product through the filling opening;

the dispenser is closed using the closure means.

The invention will be clearly understood by virtue of the following description of a particular embodiment with reference to the drawings, according to which:

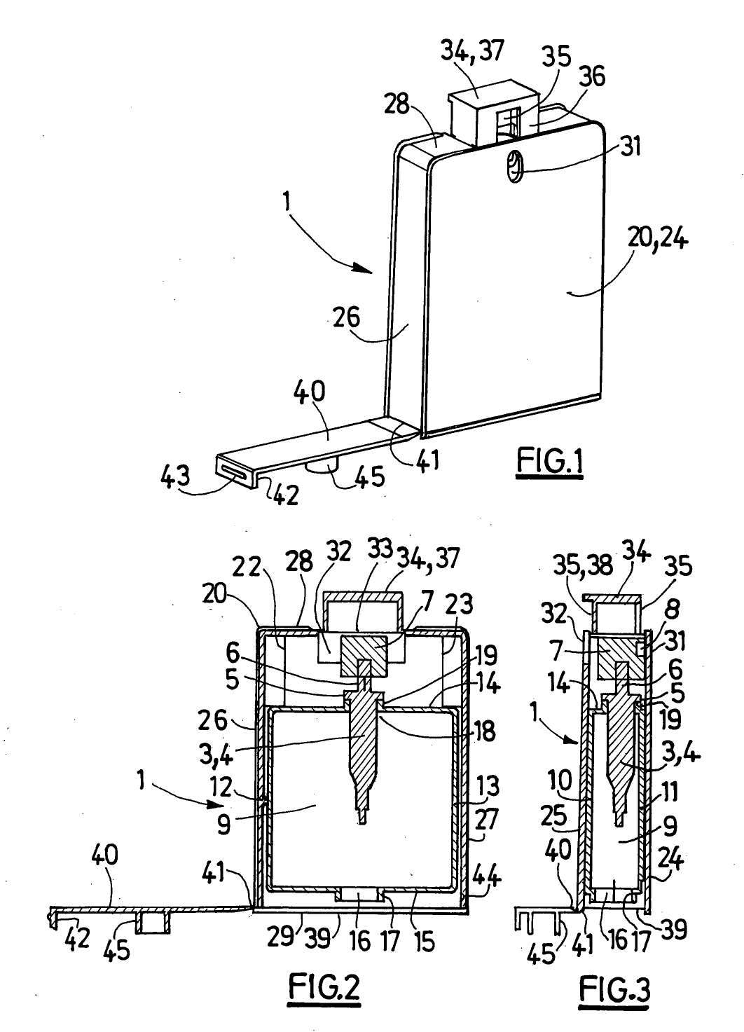

FIG. 1 is a perspective view of a container ready to be filled according to the invention;

FIG. 2 is a front view in section of the container in FIG. 1;

FIG. 3 is a side view in section of the container in FIG. 1, the closure means here being attached to the casing according to another embodiment;

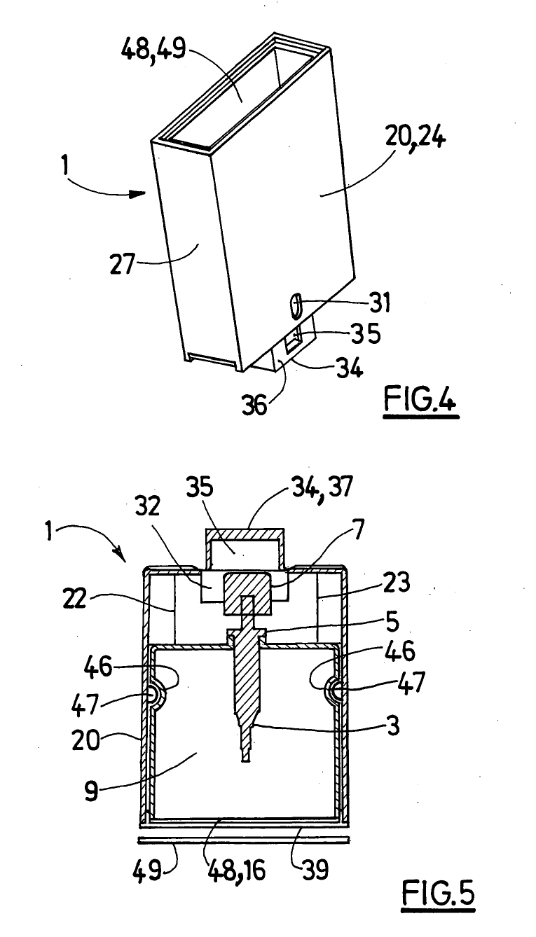

FIG. 4 is a perspective view of a container, seen from below, according to a second embodiment;

FIG. 5 is a front view in section of the container according to FIG. 4;

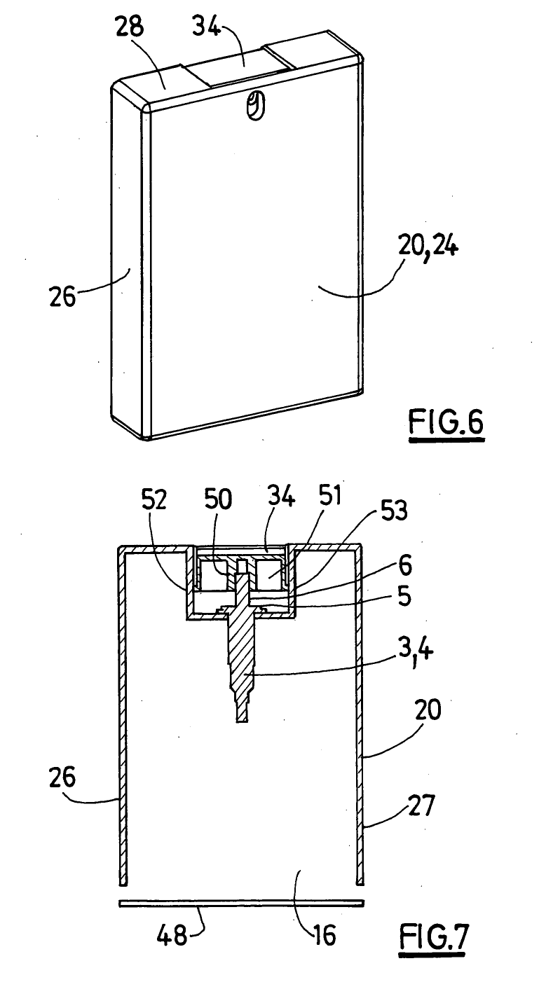

FIG. 6 is a perspective view of a container according to a third embodiment;

FIG. 7 is a front view in section of the container, in position according to FIG. 6;

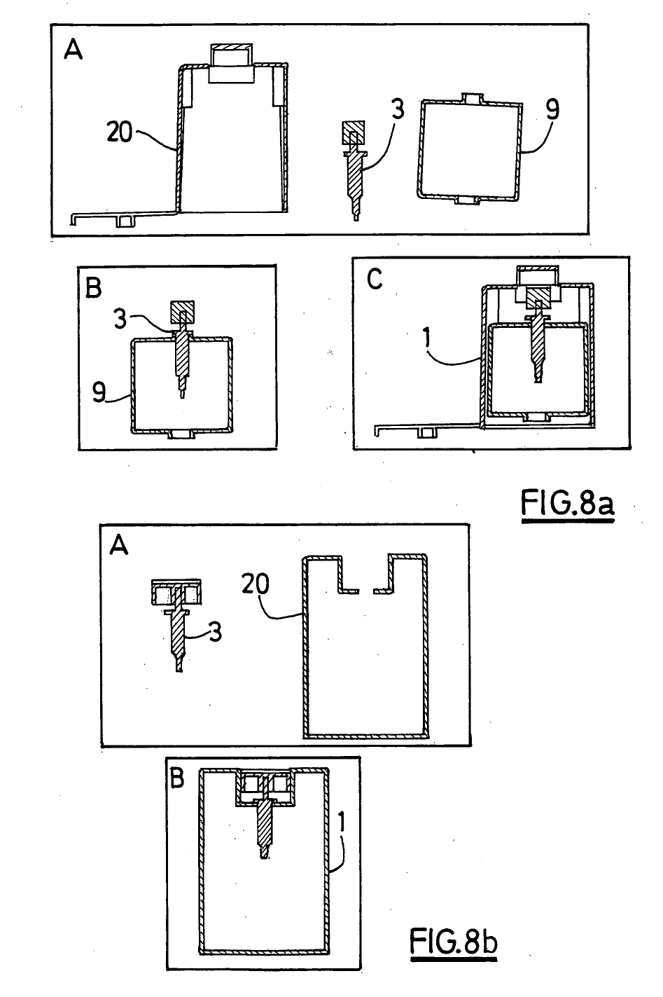

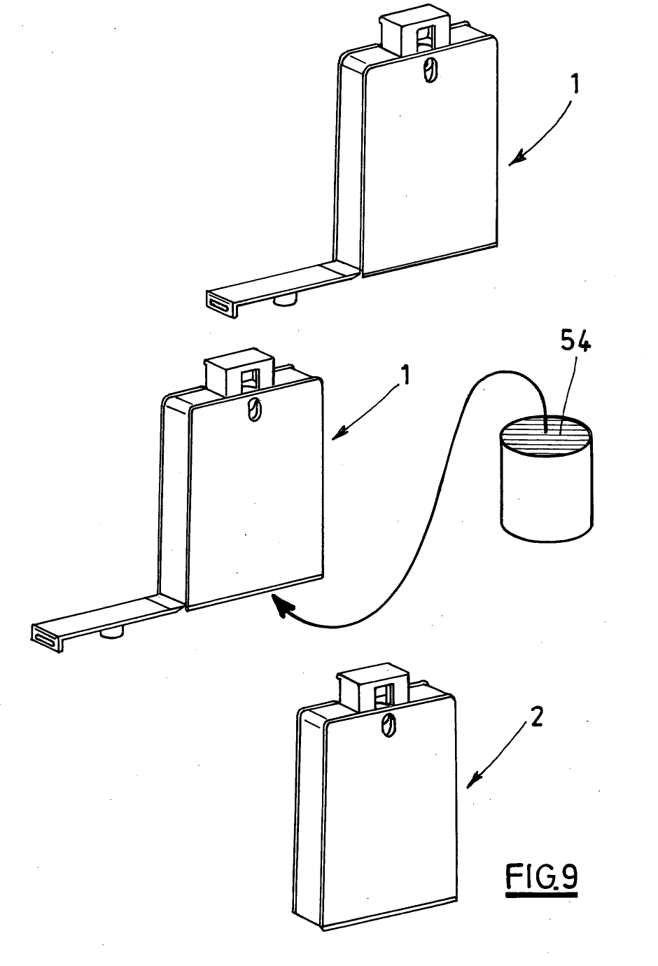

FIG. 8a is a schematic representation of the method of producing a container ready to be filled according to one of the first two embodiments;

FIG. 8b is a schematic representation of the method of producing a ready-to-be-filled container according to one of the first two embodiments;

FIG. 9 is a schematic representation of the method of producing a dispenser according to the invention.

FIGS. 1-7 depict a ready-to-be-filled container 1 intended for producing a product dispenser 2.

The term “front” is defined with respect to the side through which the product is dispensed. The term “top” will be used with reference to the area through which the product is dispensed.

The terms “rear” and “bottom” will be defined accordingly.

With reference to FIGS. 1, 2, 3, a first embodiment of the container 1 is described.

The container 1 comprises a plastic pump 3 known per se.

The pump 3 comprises a cylindrical pump body 4 intended to be immersed in the product to be dispensed.

In an embodiment which is not shown, the pump body may not be cylindrical and may, for example, have a parallelepipedal shape.

The top part of the pump body 4 has a collar 5 for the pump body 4 to rest on a support.

The top part of the pump 3 has, in an axial extension, a tube 6 onto which a cylindrical dispensing head 7 is fitted.

The dispensing head 7 has on its side surface a hole 8 enabling the product to be expelled.

During functioning, the head 7 is caused to make a travel of height c.

The connection between the hole 8 and the tube 6, as well as the general functioning of the pump 3, are known.

The pump 3 is intended to be placed on a reservoir 9 of product to be dispensed.

As can be seen in FIGS. 2, 3, the reservoir 9 is mainly parallelepipedal.

The reservoir 9 is made from plastics material, and is obtained by moulding or injection. It comprises two large lateral faces 10, 11 and two small lateral faces 12, 13 as well as a top face 14 and a bottom face 15.

The corners between the small lateral faces 12, 13 and the top 14 and bottom 15 faces are rounded.

The lateral faces 10, 13 have no orifice. On the other hand, the top 14 and bottom 15 faces have a hole at their centre through a circular opening.

In an embodiment which is not shown, the top 14 and bottom 15 faces can be situated on either side of the centre of the face. In addition, the openings can have different shapes: square, rectangular, oval or other.

The bottom face 15 is provided with a product filling opening 16 on the circumference of which the bottom face 15 is extended by a filling projection 17 projecting towards the outside of the reservoir 9.

The top face 14 is provided with a product dispensing opening 18. On the circumference of the opening 18, the top face 14 is extended by a dispensing projection 19 projecting towards the outside of the reservoir 9.

In the embodiment depicted, the dispensing projections 17, 19 are cylindrical projections.

The filling opening 16 and the dispensing opening 18 have diameters in the same order of magnitude. The projections 17, 19 have a height which does not exceed the length of the radius of the openings 16, 18.

The reservoir 9 is intended to be placed in a casing 20 which forms the outside of the container 1.

The casing 20, made from plastics material, is essentially parallelepipedal.

In an embodiment which is not shown, the casing 20 can have a circular, oval or other cross-section.

The casing 20 comprises means 21 for the relative fixing of the casing 20 and reservoir 9.

Like the reservoir 9, it comprises two large lateral faces 24, 25, two small lateral faces 26, 27, a top face 28 and a bottom face 29.

On the internal top surface of the large lateral faces 24, 25 intended not to be in contact with the reservoir 9, there extend two rectilinear fixing projections 22, 23.

These fixing projections 22, 23 extend from the top of the face 24, 25 as far as the level provided for the top of the reservoir 9.

Other fixing means can be provided for respectively fixing the reservoir 9 in the casing 20.

The two small lateral faces 26, 27 have no opening.

One of the large faces, the front face 24, is provided with a product dispensing aperture 31 situated in the immediate vicinity of the end of the front face 24.

The aperture 31 is oblong in shape, the parallel sides of the aperture being vertical. The height of the aperture 31 is designed to correspond to the travel c of the dispensing head 7.

The other large face, the rear face 25, comprises a rectangular cutout 32 which extends from the top edge of the face 25 downwards over a distance corresponding to the bottom of the product dispensing aperture 31.

The top face 28 has an actuation opening 33 enabling a pusher 34 to be positioned and actuated.

In the embodiment depicted, the actuation opening 33 is situated at the centre of the top face 28. In terms of width, it occupies a distance corresponding to the width of the casing 20 minus the thickness of the two faces 24, 25. In terms of length, it occupies approximately one third of the length of the top face 28.

In an embodiment which is not shown, the actuation opening 33 can be situated elsewhere than at the centre of the top face 28.

The pusher 34 is adapted to the dimensions of the actuation opening 33.

The pusher 34 is parallelepipedal in shape. It is made from plastics material and forms a single piece with the casing 20. They are moulded together, but according to a variant embodiment they may be moulded separately. The pusher 34 is intended to actuate the pump 3, enabling the dispensing head 7 to be moved.

The pusher 34 has a rectangular cutout 35 on its front face 36. This cutout 35 extends from the bottom of the front face 36 and extends in width over the central third of the face 36. A strip of material on the front face joins the top of the cutout 35 to the top face 37.

The other lateral faces are closed.

The top face 37 of the pusher 34 slightly projects towards the rear with respect to the rear face 38 of the pusher 34 so that the top face 37 does not project with respect to the rear face 25 of the casing 20.

In order to dispense the product, at the time of first use, the top face 37 of the pusher 34 is pushed on, lugs connecting the pusher 34 to the remainder of the casing 20 break, the pusher 34 descends until it comes into contact with the dispensing head 7. By continuing to press, the head 7 is driven downwards so that the product is expelled.

After expulsion, the head 7, in contact with the pusher 34, rises again until the top face 37 is situated and remains at the same level as the top face 28 of the casing 20.

Finally, the bottom face 29 of the casing 20 is provided with a mounting opening 39 which extends over the entire surface of the face 29.

With reference to FIG. 2, means 40 of closing the mounting opening 39 are connected to the casing by means of a hinge 41 along the edge between a small lateral face 26 and the closure means 40.

The closure means consist of a rectangular pivoting wall 40 which pivots about the hinge 41 between an open position in which the mounting opening 39 is open and a closed position in which this opening 39 is closed.

The wall 40, made from plastics material, has the dimensions of the mounting opening 39.

On the opposite side to the hinge 41, the wall 40 is extended by a perpendicular flange 42 upwards when the wall 40 is in the closed position.

The flange 42 is provided with a rectilinear projection 43 on its side in contact with the small lateral face 27 of the casing 20 in the closed position.

The rectilinear projection 43 is intended to assist with holding the pivoting wall 40 in the closed position by coming to be inserted in a corresponding groove 44 placed on the small face 27 of the internal side of the casing 20.

The height of the flange 42 is chosen so that it is possible to pivot the pivoting wall 40 as far as the closed position and to place a projection 43 therein.

At the centre of the pivoting wall 40, on the side intended to form the inside of the casing 20, in the closed position, there is a wall projection 45.

Its form and height are chosen so that the wall projection 45 comes to be inserted in the filling projection 17, in the closed position. The wall projection 45 is, in the embodiment depicted, a cylindrical projection.

With reference to FIG. 3, the pivoting wall 40 is connected to the casing 20 by means of a hinge 41 along the edge between the rear face 25 and the bottom face 29.

Consequently, the flange 42 is intended to come into contact with the front face 24 of the casing 20, the groove 44 being placed on this front face 24, on the inside of the casing 20.

All the other elements described with reference to FIG. 2 are found in FIG. 3.

The various elements of the container 1 have been described with reference to the embodiments depicted in the figures. Variants with regard to the form, dimensions or positioning of the elements with respect to one another are possible.

The structure of the container 1 is now described.

The pump 3 is placed on the reservoir 9 so that the body of the pump 4 is situated inside the reservoir 9 and the tube 6 and dispensing head 7 are situated outside.

The pump body 4 blocks the product dispensing opening 18.

The top part of the body of the pump 4 is in contact with the cylindrical dispensing projection 19 and the support collar 5 rests on the top of the projection 19.

The reservoir 9 provided with a pump 3 is situated inside the casing 20.

In this position, the dispensing head 7 is flush with the actuation opening 33 and the top face 28 of the reservoir 9 is in contact with the bottom end of the fixing projections 22, 23.

The bottom of the reservoir 9 is situated above the mounting opening 39 at a distance equivalent to approximately twice the height of the filling projection 17.

In the closed position, the pivoting wall 40 is closed on the mounting opening 39. The flange 42 is in contact with one of the faces of the casing 20, the rectilinear projection 43 being placed in the corresponding groove 44.

The wall projection 45 is in contact with, and inside, the filling projection 17 so that the filling opening 16 is closed.

A second embodiment of the ready-to-be-used container 1 according to the invention is now described with reference to FIGS. 4 and 5.

The container 1 still comprises a pump 3, a reservoir 9 and a casing 20.

The pump 3 is the same as in the first embodiment.

The reservoir 9 has a product dispensing opening 18, a cylindrical dispensing projection 19 and a filling opening 16.

The filling opening 16 extends here over the entire surface of the bottom face 15 of the reservoir 9.

The small lateral faces 12, 13 of the reservoir 9 are also provided with semi-cylindrical notches 46 extending horizontally over the entire width of the faces.

The notches 46 form a projection towards the inside of the reservoir 9 and are placed at the upper third of the height of the reservoir 9. In other embodiments, they could be placed at a different distance, or have a different shape or orientation.

These notches 46 are intended to enable the reservoir to be snapped into the casing 20.

To this end, the casing 20 has two semi-cylindrical bulges 47 corresponding to the notches 46 in the reservoir 9.

The various apertures 31, cutouts 32, 35 and openings 16, 18, 33, 39 and the pusher 34 are the same as in the previous embodiment.

The closure means differ in that, in the open position, they are not connected to the casing 20.

The closure means consist of a first wall 48 and a second wall 49.

The first and second walls 48, 49 can be a plate made from rigid plastics material or a film of plastics material.

In the closed position, the first wall 48 closes off the filling opening 16, the second wall 49 closes off the mounting opening 39.

A third embodiment of the ready-to-be-used container 1 according to the invention is now described with reference to FIGS. 6, 7.

The container 1 comprises a pump 3 and a casing 20. The reservoir function is fulfilled directly by the casing 20.

The pump 3 comprises a pump body 4, the top part of which has, in an axial extension, first of all a support collar 5 and then a tube 6 onto which a rectangular dispensing head 7 is fitted. The pusher is here merged with the dispensing head 7.

In other embodiments which are not shown, the dispensing head can have a shape other than rectangular, oval, circular etc.

To fit on the tube 6, the dispensing head 7 has a cylindrical part 50 surrounding the top of the tube 6.

The dispensing head 7 has, in the cylindrical part 50, a hole 8 enabling the product to be expelled.

The top of this cylindrical part 50 is connected to a rectangular plate 34, fulfilling the role of pusher, which gives the head 7 its rectangular shape.

Along the edges of the rectangular plate 34 and towards the bottom, four pusher faces extend. The faces extend only as far as the level of the bottom of the cylindrical part 50.

As in the first embodiment, the plate 34 projects towards the rear with respect to the rear face of the dispensing head/pusher 7.

Finally, the face opposite the hole 8 is cut as necessary to allow the dispensing of the product.

The casing 20 is a parallelepiped made from plastics material.

The mounting/filling opening 16 occupies the entire surface of the bottom face 15.

The product dispensing aperture 31 on the front face 24, the actuation opening 33 on the top face 28 and the rectangular cutout 32 on the rear face 25 are the same as in the first embodiment.

The top face 28 has an open cavity 51 intended to accept the dispensing head 7.

The walls of the cavity are delimited by two symmetrical steps 52, 53.

The symmetrical steps 52, 53 are parallel to the lateral faces 26, 27 of the casing 20.

In other embodiments which are not shown, the steps 52, 53 can be curved or arched or form a non-right angle with the top face 28 etc.

The front face of the cavity corresponds to the part of the front face 24 of the casing 20 comprising the product dispensing aperture 31.

The rear face of the cavity corresponds to the part of the rear face 25 of the casing 20 comprising the rectangular cutout 32.

The bottom of the cavity comprises the product dispensing opening 18 on which the pump 3 is mounted.

As in the second embodiment, the closure means 40 are not connected to the casing 20.

The closure means 40 consist of a first wall 48. This first wall 48 can be a plate made from rigid plastics material or a plastic film.

In the closed position, the wall 48 closes off the filling opening 16 and the mounting opening 39, which are merged.

With reference to FIG. 8a, the method of producing the ready-to-be-used container 1 according to the first two embodiments is described.

First of all, a pump 3, a casing 20 and a reservoir 9 are procured (step A).

The pump 3 is placed on the reservoir 9 by means of the dispensing opening 18 (step B).

The reservoir 9 provided for the pump 3 is placed in the casing 20 through the mounting opening 39, fixing them respectively to each other according to the means provided for this purpose (fixing or snapping-on means, or other means not shown) (step C).

The container 1 is then obtained, ready to be filled with the product, the filling opening 16 and the mounting opening 39 remaining open.

With reference to FIG. 8b, the method of producing the ready-to-be-filled container 1 according to the third embodiment is described.

A pump 3 and a casing/reservoir 20 are procured (step A).

The pump 3 is placed on the casing/reservoir 9 through the dispensing opening 18 (step B).

The container 1 is then obtained, ready to be filled with the product, the filling/mounting opening 16 remaining open.

With reference to FIG. 9, a method of producing the dispenser 2 is described.

A ready-to-be-filled container 1 is produced by the previous method (step I).

The container 1 is filled with product (54) through the filling opening 16 (step II).

The dispenser 2 is closed by means of the closure means 40 (step III).

The closure means 40 are closed by heat sealing in the case of a plastic film, or they may be welded or snapped on.

1. A ready-to-be-filled container (1) intended for producing a dispenser (2) for a product such as a cosmetic product, a perfume or the like, comprising
means (9) for containing the product, having a product filling opening (16) and a product dispensing opening (18);
means (3) for dispensing the product, such as a pump, mounted on the means (9) for containing the product and responsive to control means (34);
means (20) forming an external casing, made from plastics material, for the means (9) for containing the product and for the means (3) for dispensing the product, with which the control means (34) are associated, having a product dispensing aperture (31) matching the outlet for the means (3) for dispensing the product, and a container (1) mounting opening (39);
the product filling opening (16) being intended, in the dispenser (2), to be closed by closure means (40);
the container (1) thus being ready to be filled with the product and then closed by the closure means (40) in order to form the dispenser (2).

2. A container (1) according to claim 1, characterised in that the means (9) for containing the product are in the form of a reservoir (9) distinct from the means (20) forming a casing and are placed in the latter.

3. A container (1) according to claim 2, characterised in that the reservoir (9) comprises several faces (10, 11, 12, 13, 14, 15), one (15) of the said faces of the reservoir (9) comprising the product filling opening (16), another (14) of the said faces comprising the product dispensing opening (18).

4. A container (1) according to claim 3, characterised in that the face (15) of the reservoir (9) comprising the product filling opening (16) and the face (14) of the reservoir (9) comprising the product dispensing opening (18) are opposite each other.

5. A container (1) according to one of claims 2 to 4, characterised in that the mounting opening (39) provided on means (20) forming a casing is able to allow the insertion of the reservoir (9).

6. A container (1) according to one of claims 2 to 5, characterised in that the means (20) forming a casing comprise means (22, 23) for the respective fixing of the means (20) forming the casing and the reservoir (9).

7. A container (1) according to one of claims 2 to 6, characterised in that the reservoir (9) comprises means (22, 23) for the respective fixing of the means (20) forming the casing and the reservoir (9).

8. A container (1) according to claim 1, characterised in that the means for containing the product and the means (20) forming a casing are formed from one and the same piece, this casing/reservoir (20) comprising the filling/mounting opening (16, 39) and the product dispensing opening (18), the dispensing means (3) being placed on the casing/reservoir (20) on each side of the product dispensing opening (18).

9. A container according to one of claims 1 to 8, characterised in that the means (20) forming a casing comprise several faces, one (29) of the said faces comprising the mounting opening (39), another one (28) of the said faces comprising a cavity (51) comprising the product dispensing opening (18).

10. A container (1) according to claim 9, characterised in that the face (29) of the means (20) forming a casing comprising the mounting opening (39) and the face of the means (20) forming an external casing comprising the cavity (51) are opposite each other.

11. A container (1) according to one of claims 1 to 10, characterised in that the means (34) of controlling the means (3) for dispensing the product are in the form of a pusher (34) mechanically associated with the casing (20), placed in line with the means (3) for dispensing the product and able to move so as to actuate the means (3) for dispensing the product.

12. A container (1) according to claim 11, characterised in that the pusher (34) and the means (20) forming a casing form the same piece, the pusher (34) being moulded in one piece with the means (20) forming the casing.

13. A container (1) according to one of claims 1 to 12, characterised in that the closure means (40) comprise a pivoting wall (40) pivoting about an edge forming a hinge (41) for the means (20) forming a casing.

14. A container (1) according to claim 13, characterised in that the pivoting wall (40) comprises means (45) of closing off the projecting filling opening (17).

15. A reservoir (9) especially intended for a container (1) according to one of claims 1 to 7, characterised in that it comprises a filling opening (16) and a product dispensing opening (18), the filling opening (16) making it possible to fill the said reservoir (9) with product, the product dispensing opening (18) being intended to receive means for dispensing the product (3), the reservoir (9) comprising several faces, the face (15) comprising the product filling opening (16) and the face (14) comprising the product dispensing opening (18) being opposite each other.

16. A casing (20) especially intended for a container (1) according to claims 1 to 14, characterised in that it comprises a mounting opening (39), a product dispensing aperture (31) intended to be in correspondence with the outlet from the means (3) for dispensing the product and means (34) for controlling the means (3) for dispensing the product, the casing comprising several faces and a cavity (51) comprising the dispensing opening (18), the face (29) comprising the mounting opening (39) and the face (28) comprising the cavity (51) being opposite each other.

17. A method of producing the container, according to one of the preceding claims, characterised in that it comprises the following steps:
means (3) for dispensing the product, such as a pump, are procured;
means (20) forming a casing, made from plastics material, are procured, the means (20) forming a casing comprising a mounting opening (39);
the means (20) forming a casing and the means (3) for dispensing the product are associated together so as to place the means (3) for dispensing the product on the means (20) forming the casing
so that the mounting opening (39) is open, the container (1) thus being ready to be filled with the product and then closed by the closure means (40) in order to form the dispenser (2).

18. A method according to claim 17, characterised in that
means (9) are also procured for containing the product comprising a filling opening (16) and an opening (18) for dispensing the product;
the means (3) for dispensing the product are placed on the means (9) for containing the product on each side of the opening (18) for dispensing the product;
the means (9) for containing the product are introduced into the means (20) forming a casing through the mounting opening (39)
so that the mounting opening (39) and the filling opening (16) are opposite each other and are open, the container (1) thus being ready to be filled with the product and then closed by the closure means (40) in order to form the dispenser (2).

19. A dispenser (2) for a product such a cosmetic product, a perfume or the like, comprising a container (1) according to one of claims 1 to 14, the product to be dispensed placed in the means (9) for containing the product and means (40) of closing the container (1) which close off the mounting opening (39).

20. A dispenser (2) according to claim 19, characterised in that the closure means (40) comprise a first wall (48), such as a rigid plate, a plastic film or the like, intended to close the filling opening (16).

21. A dispenser (2) according to claim 20, characterised in that the first wall (48) is associated with the means (9) for containing the product by a method chosen from amongst the group comprising adhesive bonding, welding, heat sealing, screwing and snapping on.

22. A dispenser (2) according to one of claims 19 to 20, characterised in that the container (1) comprises the pivoting wall (40), the said pivoting wall (40) being associated with the means (20) forming a casing by a method chosen from amongst the group comprising adhesive bonding, welding, heat sealing, screwing and snapping on.

23. A dispenser (2) according to one of claims 19 to 21, characterised in that the closure means comprise a second wall (49), such as a rigid plate, plastic film or the like, closing the mounting opening (39).

24. A dispenser (2) according to claim 23, characterised in that the second wall (49) is associated with the means (20) forming a casing by a method chosen from amongst the group comprising adhesive bonding, welding, heat sealing, screwing and snapping on.

25. A method of producing a dispenser (2) according to one of claims 19 to 24, characterised in that it comprises the following steps:
a ready-to-be-filled container (1) is produced by the method according to one of claims 13 or 14;
the container (1) is filled with product (54) through the filling opening (16);
the dispenser (2) is closed by means of the closure means (40).
